(19) United States
(12) Patent Application Publication
(10) Pub. No.: US 2006/0286519 A1
(43) Pub. Date: Dec. 21, 2006

(54) Apparatus and method for personality-tailored evaluation and guidance during individual transitional events

(76) Inventors: Michael Burnham, Memphis, TN (US); J. Randolph Burnham, Westport, CT (US); Eric Sundstrom, Knoxville, TN (US)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/156,131

(22) Filed: Jun. 17, 2005

(51) Int. Cl. G09B 19/00

(52) U.S. Cl. 434/236

(57) ABSTRACT

An interactive, individual-operated self-evaluation and guidance apparatus to facilitate decisions and activities involved in a life-transitional event of a person, in which a personality inventory of personal preferences and habits is evaluated to generate personality trait scores and a personality profile with communication features based on the personality profile to tailor communications as to activities and instructions for accomplishing self-discovery activities through which the individual develops an understanding to the transitional event and through self-analysis of the activities modifies behavior relative to the transitional event. A method for an individual to engage in transitional events evaluation and guidance is disclosed.

### TECHNICAL FIELD

The present invention relates to individual evaluation and guidance apparatus and methods. More particularly, the present invention relates to apparatus and methods for providing individuals with tailored evaluation and guidance for life-transitional events.

### BACKGROUND OF THE INVENTION

The modern complex world of today involves interaction of individuals in a wide range of human activities including personal engagements with family, friends, business associates, and strangers, in personal, educational, career, social, political, and other circumstances.

A service industry has developed to assist persons with life transitional events—events such as educational achievement, career shifts, so-called empty nest, retirement, disability, family changes including marriage, birth, death or other change, to mention but few. Such service industry attempts to provide assisted insight into the circumstances and changes that are experienced in the transitional events. The service industry includes personal consultants, therapists, counselors, and others trained to assist with individuals experiencing transitional events.

One aspect of this service industry is referred to as “self-help” which generally provides no direct interaction with trained persons but provides assisted insight of personal traits and connections with an individual's habits, motives, and experiences or history. Such assisted insight provides a basis for informed exploration of opportunities presented by the transitional event and informed decision-making as to the transitional event. Self-help includes advice and guidance presented through impersonal media such as television, radio, books, and magazines, audio and video recordings. These offering are made by a number of self-help entities and providers and address most imaginable problems and goals.

The self-help industry grew generally from the book trade featuring universal advice for personal improvement, including social improvement commentary (for example, Poor Richard's Almanac by Benjamin Franklin), religious-themed literature, and more recently, secular writings and commercial enterprises (for example, Dale Carnegie's book How To Win Friends And Influence People) that offered guidance for personal development.

Yet another area of self-help targeted advice for specific situations or problems, such as stress or anxiety related to particular problems such as public speaking, excess body weight, overcoming detrimental habits, and others. Unlike universal self-improvement materials, these targeted resources address special groups of people who shared common or particular circumstances. Some such targeted advisors also offered group activities for support or encouragement of those seeking change or increased ability to handle the problem.

A third approach involves personalized advice but addresses the advice to persons with specific personality types or profiles. For example, the book by Otto Kroeger and Janet Thuesen, Type Talk: The 16 Personality Types That Determine How We Live, Love, and Work, describes 16 personality types based on four personality traits assessed using the Myers-Briggs Type Indicator (MBTI) with personality-specific guidance on matters such as resolving marital conflicts or seeking satisfactory employment. Recently, web pages or sites on a global interactive network allow self-help providers to offer personality questionnaires for assessments and to provide advice reports about relationships, career, recreations, and other topics for the particular personality.

While such various self-help information providers have been useful, there are drawbacks that limit the full potential of these. Some are somewhat impersonal and tend to be less individualistic and rather more global or universal in exposure. Lacking specifics, the person engaged in obtaining such assistance may fail to understand or carry out needed changes. So-called self-help sources such as books, videos and audio tapes communicate guidance and advice in the same terms and manner to all recipients irrespective of individual differences in preferences for information processing, problem solving, decision making, or interaction. While such self-help sources offer information and guidance generally, the drawbacks to such are that the person experiencing the life-transitional event lacks guidance and activities tailored to the individual's personality for developing options, making decisions, and preparing plans for the transitional event.

Accordingly, there is a need in the art for an apparatus and method to facilitate an individual's self-evaluation and to generate guidance tailored for the individual experiencing the transitional event. It is to such that the present invention is directed.

### SUMMARY OF THE INVENTION

The present invention meets the needs in the art by providing an evaluation and guidance apparatus that facilitates developing options, making decisions, and preparing plans for life-transitional events, comprising a central manager adapted for interactive communication through a communications link with at least one interactive communicator operable by a person involved in a transitional event to transceive information between the communicator and the central operator. A personality inventory module associated with the central manager is configured for determining personality information from the person. An evaluator uses the personality information to generate a plurality of personality trait scores and a personality profile. A resource generator selects one or more reports or activities for the person based on the personality profile for the person to develop an understanding of the transitional event. A communications generator selects one or more tailored communication features for communicating with the person as to the activity based on the personality profile. An activities module associated with each activity directs and records the activity by the person for developing by the person an understanding of the transitional event. A facilitation module assists the person in adjusting the behavior of the person relative to the event in view of the activities.

In another aspect, the present invention provides an individual-actuated evaluation and guidance method for facilitating effective decisions and actions involved in a transitional event in the life of a person, comprising the steps of:

(a) developing a personality profile and a personality trait score for a plurality of personality traits of a person involved in a transactional event;

(b) selecting at least one communication features based on the personality profile for presenting report of the personality profile and activity directions to the person;

(c) selecting one or more activities for the person to engage in based on the personality profile and communicated to the person using the selected communication features for the person to develop an understanding of the transitional event_and the person's traits in relation to that event;

(d) engaging by the person in the activities for developing an understanding of the transitional event and the person's traits in relation to that event, and modification of the behavior of the person relative to the event in view of the activities; and

(e) receiving completion indicia as to each of the activities and the results thereof.

Features and advantages of the present invention will become apparent upon a reading of the following detailed description in conjunction with the drawings and the appended claims.

### BRIEF DESCRIPTION OF THE DRAWINGS

FIG. 1 illustrates a schematic diagram of an apparatus for individuals to engage in evaluation and guidance for transitional events tailored to the individual's personality according to the present invention.

FIG. 2 illustrates a flowchart of a personality-tailored process for individuals to engage in evaluation and guidance for transitional events according to the present invention.

FIG. 3 illustrates an interactive communications screen for engaging in evaluation and guidance for transitional events according to the present invention.

FIG. 4 illustrates a screen image from a communications device for the individual engaging in self-evaluation to understand the purpose of a journal on an aspect of the self-evaluation, the resources for use and particular instructions, and questions for consideration, as well as a screen for entering comments and responses into a database.

### DETAILED DESCRIPTION

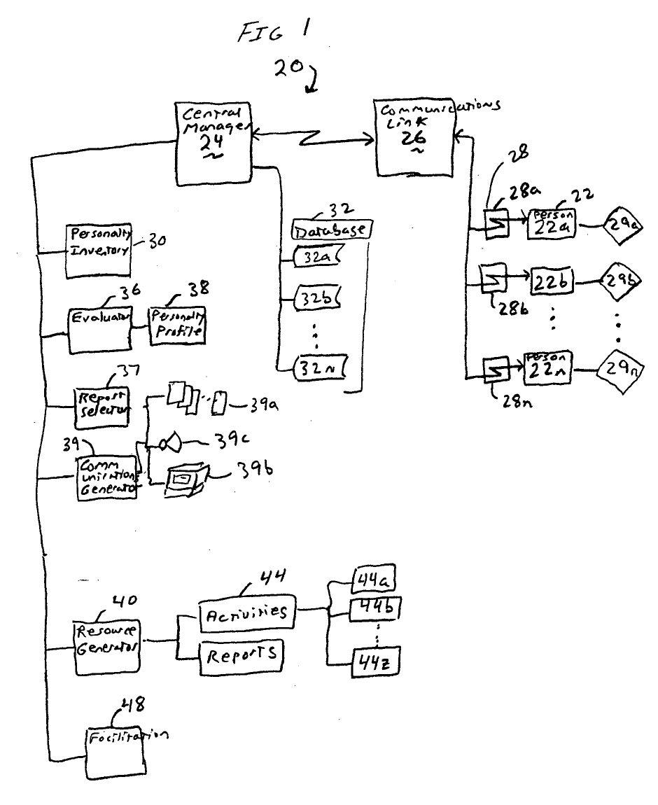

Referring now in more detail to the drawings, in which like reference numerals indicate like parts, FIG. 1 illustrates a schematic diagram of an apparatus 20 for at least one individual 22 (a plurality of individuals 22a, 22b, . . . 22n are illustrated) to engage in evaluation and guidance for transitional events in the life of the person, according to the present invention. The apparatus 20 includes a central manager 24 adapted for interactive communication through a communications link 26 with at least one interactive communicator 28 operable by the individual 22 involved in a transitional event 29 to transceive or communicate information between the communicator 28 and the central operator 26. In the illustrated embodiment, individuals 22a, 22b, . . . 22n engaged in transitional events 29a, 29b, . . . 29n use communicators 28a, 28b, 28n, respectively.

In the illustrated embodiment, the transitional event of concern for the individual is pending or recent retirement from full-time work or career. The focus is accordingly on changes in work related activities, evaluation of personal fulfillment from work and career, and guidance in selecting future pursuits that provide the desired fulfillment after transition to retirement. However, the interactive self-evaluation and guidance apparatus and method readily apply to other transitional events, for example, transitioning from high school to college; transitioning from college to career; transitioning to marriage; transitioning through divorce, and the like life-transitional events.

The central manager 24 is a microprocessor-based computer having data memory and that connects conventionally with a worldwide communications network or communications link 26, such as a web site. The individual accesses the web site central manager 24 through the communications network by a separate remote microprocessor computer.

The central manager 24 is configured with an executable software program for performing the personality evaluation and guidance for transitional events as discussed below. The central manager 24 includes a personality inventory module 30 that presents to the person sequentially a plurality of inquiries related to personal preferences, perceptions, and habits. The individual chooses from a limited number of alternative answers responsive to the inquiries. In the illustrated embodiment, the person selects one of at least five scaled alternatives. The scaled responses are transmitted to the central manager 24 for storage in a discrete database 32 of information for the individual 22, which is used for subsequent evaluation and reports.

Each of the inquiries comprises a pair of substantially opposed statements as to a personal habit, preference, or perception. For example, one pair of opposed statements is: “I enjoy going to parties and social gatherings” and “I don't enjoy going to parties and social gatherings”. Each inquiry is associated with one personality trait dimension. Each personality trait dimension has at least five, and preferably eight to ten or more, inquiries. In the illustrated embodiment, each personality trait dimension has between eight and twelve inquiries with a total of eighty such inquiries.

The scaled response by the individual to each inquiry comprises a subjective judgment by the person as to the relatively greater accuracy of one of the statements than the other. In the illustrated embodiment, the scaled response comprises an alternative selected from five mutually exclusive choices relative to each set of paired statements, including two choices for each statement that indicate its greater accuracy, namely “usually true” or “more true.” and one choice indicating that neither statement is more accurate, namely, “equally true.” Each response is communicated to the control manager 24 for storage in the database 32 associated with the person.

An evaluator 36 accesses the scaled responses of the individual and generates personality trait scores and a personality profile 38. The personality profile characterizes the individual as to a plurality of personality trait dimensions, each defined by two contrasting personality traits, and the tendency of the individual towards one or the other of those contrasting traits comprising each trait dimension. Table 1 below identifies seven personality trait dimensions used in the illustrated embodiment for evaluation and guidance purposes.

TABLE 1
Personality Trait Dimensions

| | |
|---|---|
| Contemplative | Outgoing |
| Optimistic | Cautious |
| Practical | Visionary |
| Independent | Interdependent |
| Empathetic | Analytic |
| Flexible | Structured |
| Responsive | Resilient |

The evaluator analyzes the responses by the individual, and then generates a score for each personality trait dimension, by coding the responses numerically and obtaining an average for each personality trait. The evaluator assigns one of at least five ranked, mutually exclusive categories to the individual for each of the seven trait dimensions. The ranked categories employed in the illustrated embodiment include “highly” towards one of the contrasting traits, “moderately” towards one of the contrasting traits, or “mixed” (i.e., one trait applies equally as often as the other for the particular individual).

In the illustrated embodiment, for example, the evaluator 36 assigns an individual to one of five ranked categories for the trait dimension, Contemplative-Outgoing, namely “Highly Contemplative”; “Moderately Contemplative”; “Mixed Contemplative-Outgoing”; “Moderately Outgoing”; or “Highly Outgoing.” The assignment by the evaluator is based on a cut-off score appropriate for the particular personality trait based on historical experience with responses to the particular inquiries, as is conventional in the art. The personality profile is reported to the individual, and is also used in generating a tailored report that offers guidance for the individual, based on that individual's particular combination of personality traits, for handling a transitional event.

A report selector 37 accesses the individual's personality profile as generated by the evaluator 36 from the database 32, and selects one of five tailored reports for each personality trait. For example, an individual who scored “Highly Outgoing” would receive a report for that trait, and if the individual scored “Moderately Cautious”, would receive the corresponding report, and so on, for a total of seven reports, one per personality trait dimension. (In the present embodiment, an individual receives one of 78,125 possible combinations of 5 different reports for each of 7 trait dimensions.)

A communication generator 39 accesses the individual's personality profile 38 as generated by the evaluator 36 from the database 32. The communication generator 39 selects communication features tailored to the person based on the personality profile for the activities and reports to the person to tailor them such as the medium 39a, 39b, and 39c of communication to the individual such as written or voice-recording; the medium of response, such as writing via computer keyboard or spoken voice; language used in the communication, including key-words associated with the individual's personality; and formatting, such as numbered points or undivided narrative; and the sequence of presentation, such as benefits before risks or risks before benefits. In accordance with the present invention, the communication generator tailors features of communications based on the individual's personality profile category for one or more personality traits. For example, in the best embodiment of the invention, communications tailored for “Optimistic” personalities present benefits first, then risks, whereas communications tailored for “Cautious personalities present risks first, then benefits. Similarly, communications tailored for “Empathetic” personalities address relationships and emotional experiences, whereas communications tailored for “Analytic” personalities address objective facts and rational logic.

A resource generator 40 selects one or more activities for the person to engage in based on the personality profile, which activities are designed to promote self-understanding in relation to the transitional event. For example, one activity of the resource generator is Keeping A Journal, which activity calls for journal entries by the person in response to a series of self-discovery questions. The resource generator tailors to the trait dimension “Contemplative-Outgoing” for example, through different instructions for each. “Contemplative” personalities receive instructions to reflect on the questions in solitude and write responses. “Outgoing” personalities receive instructions to discuss the questions with a group and have someone else record the main points of discussion for the person to later write into the journal. One embodiment of the invention allows for “Outgoing” personalities to dictate the journal entries by voice. “Mixed Contemplative/Outgoing” personalities receive instructions to reflect on the questions alone, then discuss the questions with another individual, and then write reflections and responses to the self-discovery questions in the Journal. Through these activities, the person develops an understanding of the transitional event and the impact of the transitional event in the life of that person. The person is thereafter better enabled to modify his or her behavior in dealing with the transitional event.

The central manager 24 includes an activities module 44 associated with each activity. The activities module 44 provides directions to the individual tailored to the individual's personality based on the personality profile. The activities module 44 records the activity by the person. Through accomplishing the activity, the individual develops an understanding of the transitional event and the individual's personal traits in relation to that event. A facilitation module 48 assists adjusting the behavior of the person relative to the transitional event in view of the activities.

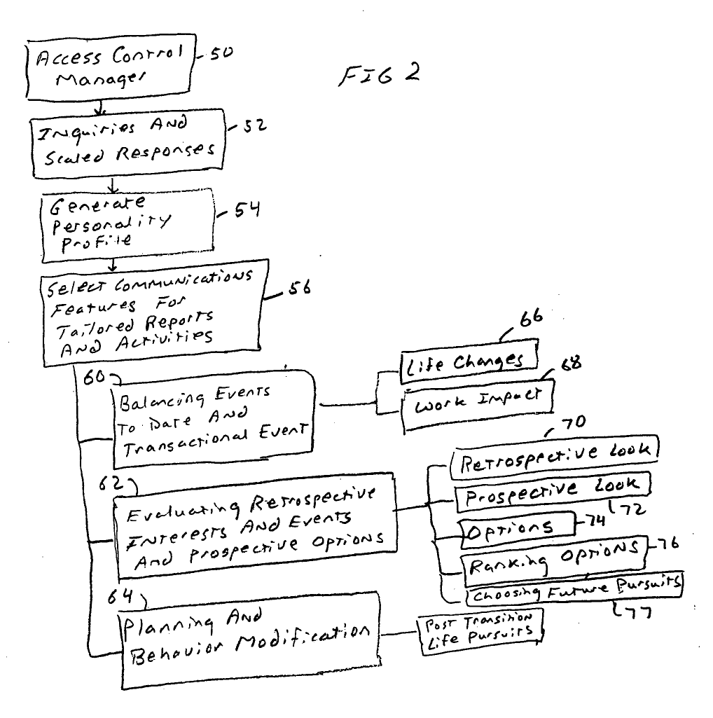

FIG. 2 illustrates a process for individuals to engage in evaluation and guidance for facilitating decisions and activities involved in transitional events in the life of that person, according to the present invention. The individual accesses 50 the control manager 24 with the communicator 28. Appropriate security login and password conventional in the art permit the individual to access the database of information associated with the particular individual. The personality inventory module 30 presents 52 to the individual the plurality of inquiries. These inquiries relate to personal preferences, perceptions, and habits. The individual responds to each of the inquiries, consisting of a pair of opposed statements, by selecting one of at least five choices. The choices include “usually true” and “more true” with respect to each of the two opposed statements, or “equally true” if neither applies more often than the other. Thus, the individual selects one scaled response relative to each of the inquiries presenting a pair of statements, which choices are mutually exclusive.

The scaled response to each inquiry is communicated to the control manager 24. Upon completion by the individual of the personality inventory, the evaluator 36 assesses the ranked responses and generates 54 the personality trait scores and personality profile.

The communications module 39 selects 56 tailored communication features based on the personality trait scores and personality profile. The tailored communication features enable the person to develop maximum understanding of the transitional event and the person's traits in relation to that event. The communication features are (a) the language and terms tailored for communicating with the individual, (b) the format of the communication tailored to the individual based on the personality score, and (c) the medium of the communication. The language and terms refers to wording tailored to communicate information effectively to the person based on the personality profile. The format refers to the presentation of information, such as bullet points in short concise wording or paragraph length details in sentence form, and sequence of presentation of information. The medium of communication (as illustrated in FIG. 1) refers to writing 39a, to visual presentation 39b, and to audible presentation 39c, as well as communication interface such as computer keyboard, mouse pointer, microphone, speaker and the like.

Table 2 identifies the tailored language and terms associated with each personality trait. Based upon the personality trait score, these terms are used selectively in various combinations for communicating to the individual information about the individual's personality as well as tailoring the guidance instructions for completing various self exploration activities (discussed below).

TABLE 2
Personality Tailored Language: Examples of Key Words

| Personality | |
|---|---|
| Trait | Language & Phrases |
| Outgoing | action/acting, talk out/through, group/social, go |
| | ahead, socialize, accessibility, |
| | stimulating/energizing environment, trial-and- |
| | error, discussion, networking, outward, put into |
| | action |
| Contemplative | reflection/reflecting, think out/think through, |
| | solitude/solitary, plan ahead, privacy, read |
| | about, research, silence, peaceful/quiet |
| | environment, contemplation, consider, |
| | understanding, inward, self-time, downtime |
| Independent | “I,” solo, specialization, initiative, |
| | independently, individual, personal, autonomy |
| Interdependent | “We,” language, teamwork, cooperative/cooperate, |
| | collaborate, joint product, mutual give and take, |
| | interpersonal/social connection, interaction |
| Structured | steps, rules & regulations, organization, step- |
| | by-step, order, decided, have things settled, |
| | discipline, restraint, duty |
| Flexible | options, flow, adapt, choices, |
| | spontaneous/spontaneity, spur-of-the-moment, live |
| | in the moment, discretion, |
| Cautious | vigilant, wary, risks, losses, hazards, problems, |
| | road-blocks, down-side, caution, careful, |
| | security, risk-avoidance, protection, vigilance |
| Optimistic | confident, hopeful, benefits, gains, progress, |
| | smooth sailing, up-side, care-free, advantages, |
| | growth, development, |
| Practical | hindsight, past, precedent, history, record, |
| | account, experience, tactics, details, |
| | practicalities, realities, facts, specific, |
| | account, concrete, hands-on |
| Visionary | foresight, future, outlook, prospects, |
| | possibilities, big-picture, vision, headlines, |
| | outcomes, long-range goals, strategy, long-term |
| | planning, theories, ideas, general, brainstorm, |
| | abstract |
| Empathetic | in-touch, feelings, emotions, sensitivity, |
| | empathy, subjective, get/have a feel for, |
| | relationships, loyalties, conflict, sympathy, |
| | compassion, warmth, passion |
| Analytic | logic/logical, dispassionate, detachment, |
| | rational, reasonable/reasoning, analyze, |
| | components, objective/objectivity, intellect, |
| | debate/argument, understanding |
| Resilient | calm, relaxed, composed/composure, resist, |
| | recover, healthy, stable, over-extended, |
| | energetic, can handle, confident, seldom |
| | stressed, bounce back fast, seldom frustrated |
| Responsive | tense, anxious, upset, react, respond, symptoms, |
| | stress/stressed, easily frustrated, setbacks, |
| | discouraged, anxiety/anxious, moody/mood-change |

The format of the activities and the instructions are also tailored to the individual based on the personality trait scores and personality profile. Table 3 below illustrates criteria for tailoring communications and self-discovery activities for the individual based on the personality profile category for selected personality trait dimensions.

TABLE 3
Tailoring Criteria

| Personality | Tailored | Tailored |
|---|---|---|
| Traits | Communication | Self-Discovery Activities |
| Contemplative | Language (key | Social interaction: Solitary |
| Outgoing | words) | activity vs. one-to-one |
| | contemplation | interaction vs. Group activity |
| | vs. action | Information processing: |
| | | Solitary writing vs. one-to- |
| | | one conversation vs. group |
| | | discussion |
| | | Data-capture: Written notes vs. |
| | | Voice record |
| Structured - | Format of | Instructions: |
| Flexible | presentation: | Suggested sequence vs. Menu of |
| | Numbered/ | options |
| | bulleted steps | |
| | or outline vs. | |
| | Unstructured | |
| | narrative | |
| Empathetic - | Language (key | Focus of suggested activity: |
| Analytic | words): | Relationships vs. data. |
| | Emotional vs. | Decision-making: Relationships |
| | Logical | vs. Performance |
| | Examples: | |
| | People-stories | |
| | vs. Data | |
| Independent - | Language (key | Work process: Solo effort vs. |
| Interdependent | words): | Joint effort |
| | Individual | Product of activity: |
| | effort vs. Group | Individual vs. Collaborative |
| | collaboration | Focus of activity: Creativity |
| | | vs. Cooperation |
| Practical - | Language (key | Activity selection: Review |
| Visionary | words): Past vs. | history vs. develop future |
| | future, | scenario |
| | Concrete vs. | Focus of activity: Process vs. |
| | Abstract, Detail | Results; Past vs. Future |
| | vs. big-picture, | |
| | Tactile/kinetic | |
| | vs. Visual | |
| Responsive - | Language (key | Activity selection: Managing |
| Resilient | words): | stress or commitments |
| | Soothe/comfort | Focus of activity: Comfort vs. |
| | vs. Challenge/ | challenge |
| | stimulate | |
| Cautious - | Sequence/ | Activity selection: Risk |
| Optimistic | emphasis in | analysis; Opportunity survey |
| | presentation: | Focus of activity: Personal |
| | Risks first, | weaknesses vs. strengths; |
| | most vs. | Possible problems vs. Desired |
| | Benefits first, | outcomes |
| | most | |

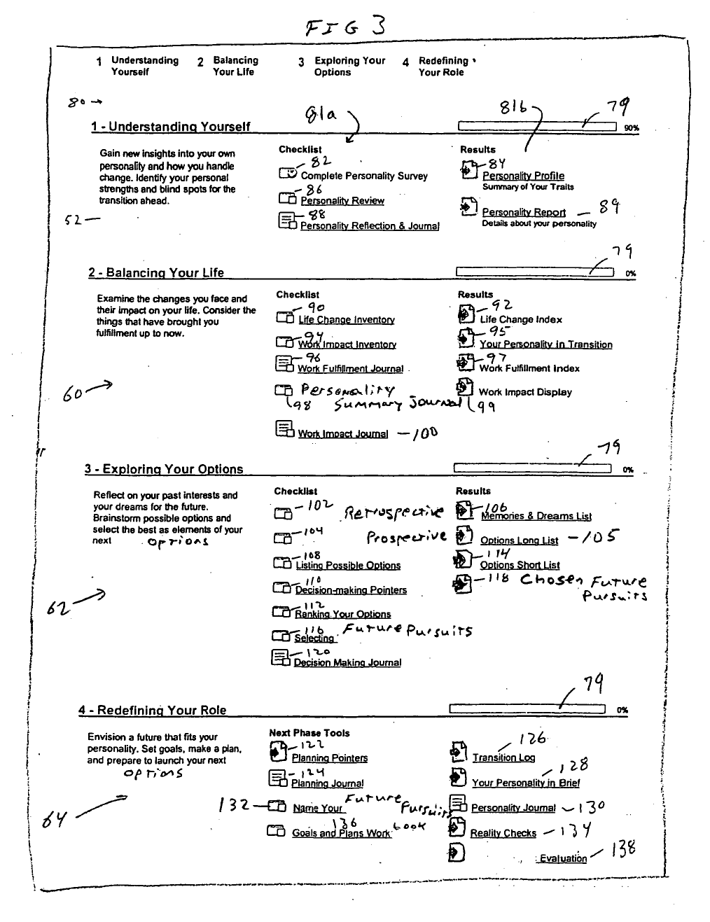

The method for guidance and evaluation comprises four steps, generally shown in FIGS. 2 and 3. After the initial step 54, which incorporates the prerequisite personality profiling and related self-understanding activities, individuals receive guidance to undertake three subsequent steps in their numerical order, but the person can choose to do these steps in a different sequence after the personality profiling. The second step 60 calls for characterizing the individual's life situation, including the overall amount of change before and after transition, the balance among potential sources of personal fulfillment before transition, and the potential, personal difficulty in achieving fulfillment after transition. The third step 62 investigates, evaluates, and selects from possible options or alternatives, future pursuits and involvements. The person identifies these possible options or alternatives via retrospective analysis of previous and current interests and prospective analysis of future interests. The fourth and final step 64 facilitates goal-setting, planning and behavior modification in carrying out the life-pursuits selected in the third step. Preferably, the activities and reports of these steps have selected features and components tailored to the individual's personality. In the current embodiment, a subset of the reports and activities incorporates tailoring, as described below.

The first step, focused on self-understanding, consists of the personality evaluation 52, and includes a tailored personality profile and report, a review activity (not tailored in the present embodiment), and a tailored journaling activity calling for written entries in response to a series of self-discovery questions. The journal activity is tailored to the personality trait dimension “Contemplative-Outgoing”. “Contemplative” personalities receive instructions to reflect on the questions in solitude and write responses. “Outgoing” personalities receive instructions to discuss the questions with a group and have someone else record the main points of discussion to later write into the journal. “Mixed Contemplative/Outgoing” personalities receive instructions to reflect on the questions alone, then discuss them with another individual, then write reflections and responses to the self-discovery questions in the Journal.

The second step 60 consists of activities for evaluating the individual's current life situation and sources of fulfillment, with tailored reports as output. This step includes life change evaluation 66 and transitional event analysis 68 (in the illustrated embodiment, work impact analysis).

The third step 62 includes retrospective identification of past and present interests 70 and a prospective, future-oriented identification of desired pursuits 72, followed by development of possible options (alternative, future pursuits) 74, with personal evaluation and ranking of those options 76, and final selection and review of the options that will comprise post-transition life-pursuits 77.

The control manager 24 provides one or more selected activities in each step for the individual to carry out. The activities are communicated to the person using one or more communication features selected to enable the person to develop maximum understanding of the transitional event and the person's traits in relation to that event. The control manager 24 communicates the personality profile and activities reports using one or more selected communication features based on the personality.

The person engages in the activities in each step as directed, and through these activities, develops an understanding of the transitional event and the person's traits in relation to that event. The individual's behavior relative to the event is modified in view of the activities. Completion indicia allow the person to track the activities and results thereof. While the illustrated embodiment shows the subsequent three steps accomplished in sequential order, it is within the scope of the invention for these steps to be undertaken in a sequence as appropriate for the individual.

FIG. 3 illustrates an interactive communications screen 80 accessible through the communicator 28 for guiding the individual through the four-step self-evaluation and tailoring process intended to facilitate self-understanding. The screen displays the four steps 52, 60, 62, and 64, and includes links by which the individual accesses the activities and reports associated with each step. The interactive screen 80 includes a checklist section 81a and a results section 81b for each step. Each step includes a “meter” generally 79 that provides a visual indication as to how much of the recommended activities has been accomplished.

The personality review 52 section includes a personality survey 82 and the resulting personality profile 84 that summarizes the individual's traits. A personality review 86 enables the individual to internalize the personality profile with a review to sharpen insights gained through the self-evaluation process. During this review step, and subsequent activities steps, the individual can choose to maintain a multi-part, tailored, written journal 88 that supports the transition and focuses the self-understanding from the personality review above. The personality report 89 contains advice and guidance specific to the individual's personality profile for identifying, appraising, planning, and managing the transitional event and future pursuits.

The second step 60 includes a life change inventory 90 that results in a life change index 92. The life change index 92 indicates the overall amount of change and the relative ability of the individual to deal with life changes as a function of the individual's personality. A work impact inventory 94 assesses the sources of personal fulfillment the individual has received from work or career and the impact of work in the life of the individual through an index of the proportion of fulfillment arising from work and career, the work fulfillment index 97. A report describing the individual's responses to transitions as a function of personality 95 offers guidance in managing issues signaled by the numerical life change index 92 (generated from responses to the life change inventory 90) and a numerical work fulfillment index 97 (generated by responses to the work impact inventory of sources of fulfillment 94) reflects the significance of work to the individual. A tailored work fulfillment journal 96 offers self-discovery questions. A summary section 98 assists the individual in reviewing the life and work aspects of the self-evaluation. A graphical display 99 is accessible for facilitating the individual's understanding of this section. A work impact journal 100 is accessible to record information about the balancing section.

Activities and reports in the third step 62 include guides for the individual to conduct a retrospective analysis of personal interests past and present 102, and a prospective analysis of desired, personal interests and pursuits for the future 104 to identify the widest range of future possibilities. The sequence of these two activities can be tailored to the particular personality trait dimension “Practical-Visionary”. “Visionary” personalities receive instructions to do the prospective analysis 104 first, followed by the retrospective analysis 102. In contrast, the tailoring for “Practical” personalities provides instructions to do the retrospective analysis 102 first, and then the prospective analysis 104. “Mixed Practical/Visionary” personalities receive a description of both prospective and retrospective analyses, and instructions that the person start where it seems appropriate and to work back and forth between the two analyses. Together the retrospective and prospective analyses yield a list of past recollections and future aspirations (a “memories and dreams list”) 106.

The individual uses the list of recollections and aspirations as the basis for generating a long list of possible, future options 108. As a basis for self-understanding in the process of deciding which of these options to pursue, the individual receives a tailored report 110 that describes the individual's personality in relation to decision-making and offers advice on effective decisions for the future. A decision-making journal 120 offers self-discovery questions for consolidating self-understanding about personal decision-making.

The individual proceeds to an activity 112 that offers instructions for narrowing the long list of options to a shorter list. While these instructions are the same for all persons in the current embodiment of the invention, the instructions are readily tailored based on personality trait dimension “Cautious/Optimistic”. The person thereby sorts the options into ranked categories of good, better, and best, to yield a few, selected pursuits for the next stage of life after the transition 114. For example, “Cautious” personalities receive instructions in 112 to eliminate options with disadvantages and risks. In contrast, “Optimistic” personalities receive instructions to first identify options that offer greatest advantages and benefits. “Mixed Cautious/Optimistic” personalities (or “Realistic”) receive instructions to evaluate both the risks and benefits, the advantages and disadvantages, of each option and select those considered to be with best balance. A review and selection activity 116 calls for evaluating the list of best options for the future, to yield a final list of the life-pursuits for the next stage of life 118.

The fourth step of the evaluation and guidance process 64 includes a tailored report concerning the individual's personal style of planning and advice about making effective plans for the future 122. The individual receives tailored instructions for consolidating self-understanding about planning styles in an activity involving a planning journal 124. A transition log 126 reflects these plans. A summarized personality report 128 can be accessed as well as the personality journal 130 for consolidating personal insights from earlier activities. The individual's chosen pursuits for the future, after the transitional event, identified 132, results in self-generated, automatic communications of reminders (for example, self-e-mails) to evaluate the results of the plans once begun 134. A tailored goals and planning workbook 136 facilitates planning and yields an evaluation 138 for the individual.

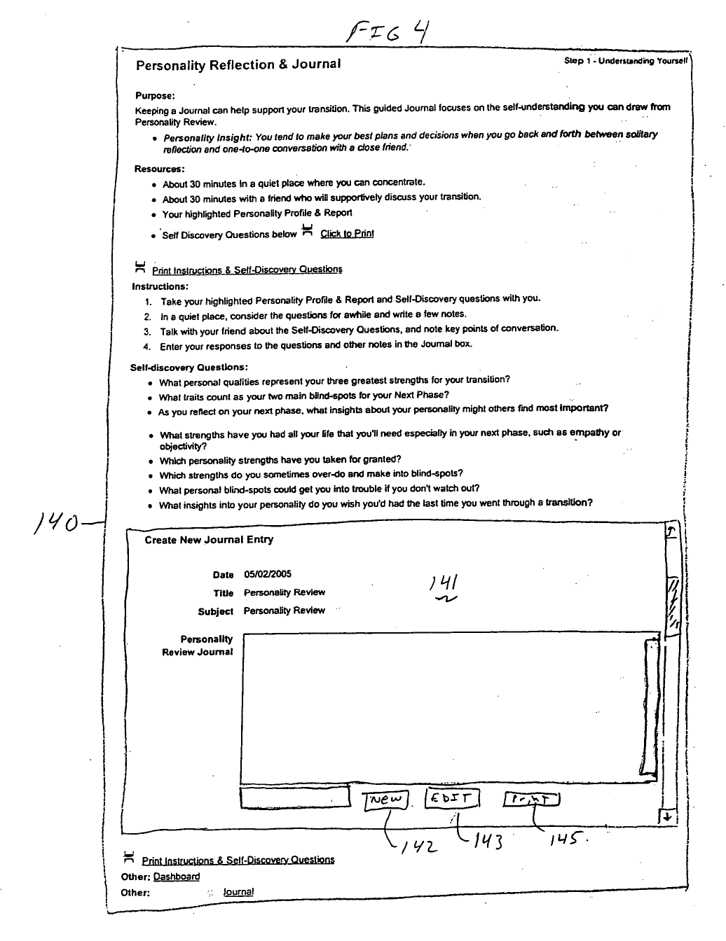

FIG. 4 illustrates a screen 140 for the personality reflection and journal 88. This helps the individual address issues related to the transitional event in subsequent activities. The screen 140 includes the purpose of the personality reflection, explains the resources that are available, provides instructions, and provides a list of questions for the individual to consider. A create new journal field 142 enables the individual to place notes in the database 32, which can be reviewed, edited 143 and printed 145.

With reference to FIG. 1, the individual after initially accessing the control manager 24 and entering appropriate security log-in and password, accesses the database 32 associated with that individual. The individual first accesses the personality inventory module 30 to complete the personality inventory by responding to inquiries related to personal preferences, perceptions, and habits. A scaled response relative to each of the inquiries is made and recorded in the database 32. The evaluator generates the personality trait scores and personality profile. The personality report is accessible to the individual. The control manager communicates the personality report in language and in format tailored to the individual based on the personality trait score.

The individual reviews the personality report. This is accomplished by reading the personality report and marking items of strength and items of personal vulnerability in contrasting colors. During this review step, and subsequent activities steps, the individual maintains a written journal 88 that supports the transition and focuses the self-understanding from the personality review above. Self-discovery questions are presented, tailored as to language and format communication features as discussed above with respect to Tables 2 and 3. The questions are considered by the individual in accordance with the guidance instructions. The instructions are tailored for the individual based on the personality trait score. For example, an individual who is highly contemplative would be instructed to consider the questions alone for a period of time, and subsequently, engage in discussions with another, such as one-on-one or small group conversations. During these discussions, the individual makes notes and enters those into the journal.

The life change inventory 90 is the first activity of the second step 60. The life change inventory 90 assesses changes in the individual's life, measures the degree of change, and offers insight to the individual on how persons with that personality profile respond to such changes. With that information, the individual may modify the behavior to handle the life change more successfully. The life change inventory in the illustrated embodiment considers thirteen discrete aspects of life as listed in Table 4 below. The individual identifies changes in the prior 12 months or expected changes, and whether the change was voluntary.

TABLE 4
Life Domains Evaluated for Major or Minor Change

| | |
|---|---|
| 1. | Mate - relationship with spouse or life-partner |
| 2. | Family - children, parents, siblings, relatives |
| 3. | Friends - personal and social connections, near and far |
| 4. | Health - wellness, fitness, eating, sleeping, personal care |
| 5. | Service - volunteer or pro bono work, assistance to others, |
| | giving |
| 6. | Work - paid job, profession, occupation, business or calling |
| 7. | Home - location, design, furnishing, upkeep, routine |
| | maintenance |
| 8. | Self-development - education, training, workshops, self-study |
| 9. | Money - finances, income, bills, credit, loans, taxes |
| 10. | Recreation - fun, leisure, play, hobbies, travel, relaxation |
| 11. | Spirituality - church, religion, introspection |
| 12. | Community - involvement in governance, civic organizations, |
| | clubs |
| 13. | Other - matters not included above |

The Evaluator module 36 receives the responses to the Life Change Inventory 90 and generates a Life Change Index 92, a numerical score from 1 to 10 indicating the overall amount of change that characterizes the individual's transition. The Resource Generator 40 uses the Life Change Index 92 to create a brief report tailored to the individual's personality, concerning the individual's likely, emotional experience of stress and challenge based on the personality profile.

The work impact inventory 94 assesses sources of fulfillment that an individual might have obtained in the past and/or present from work and other parts of life, toward understanding what fulfillment has come from work and career, which the individual might want to replace after retiring from full-time work or otherwise changing careers. This inventory incorporates pursuits that replace the areas of fulfillment that the individual was receiving through and from work. The results are referenced when elements for the next options are selected. The work impact inventory 94 addresses the amount of satisfaction derived by the individual as to the work impact topic rated on a five-element scale: “very satisfied”, “satisfied”, “neither”, “dissatisfied”, “very dissatisfied”; and the importance derived by the individual rated on a five-element scale: “extremely important”, “very important”, “important”, “slightly important”, and “not important”. Table 5 below lists sources of fulfillment for the person to rate.

TABLE 5
Possible Sources of Fulfillment (Rated on Satisfaction, Importance,
and Portion of Satisfaction from Work)

| | |
|---|---|
| 1. | Recognition - Having people acknowledge and appreciate what you |
| | do; applause. |
| 2. | Time structure - Having responsibilities, duties, and |
| | commitments that organize your days. |
| 3. | Purpose - Knowing that what you do has meaning, value, and |
| | significance for yourself and/or others. |
| 4. | Helping others - Providing service; nurturing, mentoring, |
| | assisting, and supporting people. |
| 5. | Community - Actively participating in civic projects, |
| | associations, organizations. |
| 6. | Family - Enjoying time with loved ones: your mate, children, |
| | siblings, and/or relatives. |
| 7. | Professional affiliation - Regular interaction with others |
| | involved in the kind of work you do. |
| 8. | Friendship - Spending time with your friends and companions. |
| 9. | Social connection - Networking; staying in touch, informed, and |
| | up-to-date via personal contacts. |
| 10. | Mental challenge - Intellectual excitement; pursuits that |
| | stretch your mind and keep you sharp. |
| 11. | Physical activity - Regular exercise for recreation or fitness, |
| | such as walking, yard-work, or a sport. |
| 12. | Influence - Exercising power, authority, leadership, or status |
| | through what you do. |
| 13. | Collaboration - Cooperating in joint efforts; working and/or |
| | playing as a member of a team, committee, or group. |
| 14. | Earning - Generating income from your efforts; getting paid for |
| | what you do. |
| 15. | Creative expression - Producing artistic, innovative, original |
| | ideas or works. |
| 16. | Environments - Functional, pleasing places that give needed |
| | comfort, solitude, interaction, and/or stimulation. |
| 17. | Independent accomplishment - Individual achievement through |
| | sustained, personal effort. |
| 18. | Travel - Journeying to visit (or re-visit) distant, enjoyable |
| | places. |
| 19. | Spirituality - Participating in church, worship, religion, |
| | spiritual practice, or introspection. |
| 20. | Self-development - Life-long learning, education, training, or |
| | study. |

The result of the life change inventory 90 and the work impact inventory 94 is a personality in transition report 95 which summarizes the personality of the individual in transition and can be used to further develop self-understanding.

During the second step of the evaluation and analysis 60, the individual can make entries in a work fulfillment journal 96, a personality summary journal 98, and a work impact journal 100. Each is presented on a screen similar to that shown in FIG. 4, and includes an explanation of the purpose of the journal, resources to be used, and instructions for competing tasks within the particular portion of the self-discovery evaluation, and questions for consideration. Each journal includes text entry to the database 32 that can be reviewed, edited, and printed for consideration during completion of the balancing evaluation or later as necessary.

The retrospective analysis of past and present interests 102 facilitates identification of possible pursuits for the future by encouraging the individual to remember events and things enjoyed from the past, with reference to the topics listed in Table 6 below. While the instructions can be tailored in accordance with the present invention, the use of old pictures, journals, or reminiscing with a close person helps with this activity. Recollection entries are included in the database 32, for example, using an entry screen 141 as illustrated in FIG. 4. Table 6 below lists topics for retrospective analysis.

TABLE 6
Topics for Retrospective Analysis of Past & Present Interests

| | |
|---|---|
| 1. | Interests and hobbies |
| 2. | Activities pressured into as a child but would like to |
| | try again |
| 3. | Classes the individual received the most from |
| 4. | Sports and extra-curricular activities |
| 5. | Talents that the individual did not develop when younger |
| 6. | Activities that people important to the individual |
| | inspired the individual to pursue |
| 7. | What the individual looked forward to doing in past and |
| | current jobs |
| 8. | Memorable trips, vacations, destinations, and seasonal |
| | activities |
| 9. | Clubs and organizations most enjoyed by the individual |
| 10. | Happiest times as a child, teenager, or young adult |
| 11. | Satisfying achievements from youth and work |
| 12. | Tasks in work enjoyed by the individual recently and hope |
| | to continue |
| 13. | Other |

The prospective analysis of desired, future interests and accomplishments 104 facilitates identification of possible, alternative pursuits referred to in flow chart as options long list 105 for the future by encouraging the individual to think of things the person has hoped to do, activities currently being done that are worth continuing, and like topics, as listed in Table 7 below. The instructions for the prospective analysis can be tailored based on the personality profile. The options long list 105 of prospective interests resulting from this activity is accumulated and stored in the database 32. The individual can modify the list at will.

TABLE 7
Topics for Prospective Analysis
of Desired, Future Pursuits and Accomplishments

| | |
|---|---|
| 1. | Things the individual wanted to do, or is currently |
| | doing, and wants to continue |
| 2. | Activities with important people that the individual |
| | wants to sustain |
| 3. | Things most wanted to do but not accomplished yet |
| 4. | Interests the individual yearns to pursue |
| 5. | Skills and talents the individual wished to develop - |
| | ways in which the individual wants to grow |
| 6. | Things the individual hopes to accomplish |
| 7. | Places the individual wants to go |
| 8. | People the individual dreams of knowing or knowing better |
| 9. | Things the individual wants to learn about; curiosities |
| | to be satisfied |
| 10. | Roles the individual might like to explore |
| 11. | Ways the individual would like to contribute, make a |
| | difference, or be remembered |
| 12. | Things the individual is doing that the individual will |
| | do differently in the future |
| 13. | Other dreams |

The listing of possible options 108 involves review and appreciation of the list of memories and dreams 106. A long list of options is generated without concerns or limitations, to provide a starting point for applying realistic limitations to evaluate possible options. For example, a memory is playing soccer in high school. Options from that memory could include coaching soccer, refereeing soccer matches, traveling to soccer sports events, writing a book on soccer, buying a soccer team, and playing on a soccer team.

The decision-making pointers report 110 provides a summary of personal decision-making habits and approaches to making decisions, based on the individual's personality profile. A decision-making journal is presented on a screen similar to that in FIG. 4, to accompany the decision-making pointers report. The purpose is to allow the individual to explore his personal decision making style, so that the individual has increased self-awareness of making decisions to assist while narrowing the options long list 105. The screen includes a purpose, the resources available, instructions to be followed, and provides a list of self-discovery questions for the individual to consider. A create new journal field enables the individual to place notes in the database 32 as to the options considered by the individual, which can be reviewed, edited and printed. This sharpens the individual's self-understanding in preparation for selecting a few, future pursuits from the options long list 105.

To accomplish this, the individual must narrow the long list of options to an options short list 114. This is accomplished by assigning the options to one of three groups labeled “OK”, “better”, or “best”. The options can then be sorted by these ratings, as well as printed. The ratings are included in the database 32 for the individual. The options labeled as “best” become the options short list 114.

In the next activity, selecting future pursuits 116, the individual reviews the options short list 114 to make a final selection of best options to retain as chosen, future pursuits 118 for the next stage of life. The individual receives instructions for reviewing, evaluating, and if necessary modifying the options short list 114. The modified list comprises the individual's chosen, future pursuits 118 for the next stage of life, and the basis for future planning.

Finally, the individual engages in planning, and implementing, the chosen, future pursuits. Through the facilitations module 48, the individual receives a planning pointers report 122, concerning personal traits related to planning, along with a planning journal activity to consolidate self-insights about planning, with space for a written entry similar to that shown in FIG. 4. The planning journal supports the transition by the individual refreshing his self-understanding during the planning and evaluation portion. Resources to use include self-discovery questions. Entries to the journal are placed in the database 32. The individual then gives a name to the chosen future pursuits 132. A title that captures the spirit of the transitional event such as a personal direction or theme often provides focus for goals and plans for the future.

The individual then receives a personally tailored, goals and planning workbook, which is printed on paper. The workbook is tailored to the personality trait dimensions “Practical-Visionary” and “Flexible-Structured”. “Practical” personalities receive instructions to establish specific goals and identify measures of progress toward accomplishing the goals, whereas “Visionary” personalities only receive instructions to establish specific goals. “Structured” personalities receive instructions to identify specific actions to implement each goal, and to specify times for completing each action, whereas “Flexible” personalities receive instructions just to specify actions to implement their goals. The goals and plans become the basis for the individual's next stage of life.

Table 8 below summarizes the resources provided through the illustrated embodiment of the present invention to a person undertaking a life transitional event to facilitate the person's understanding and success in the transitional event. The resources include the personality inventory, the various exercises, and the reports that communicate information to the person about handling the transitional event. Table 8 provides a brief description of the resource and identifies the tailoring of the resource based on the personality trait scores, as discussed above.

TABLE 8
Self-Evaluation Of Transitional Events
With Tailored Guidance

| | | |
|---|---|---|
| | Brief Description | Personality |
| Resource | Of Resource | Tailoring |

Step 1: Understanding Yourself (Gaining self-insight from
personality profile & tailored guidance report)

| | | |
|---|---|---|
| Personality | 80 structured inquiries, each | Not tailored. |
| Survey or | asking for a choice from 5 | Same instructions + |
| Inventory | mutually exclusive, alternative | questions + choices |
| 52 | responses, collectively | for all persons. |
| | evaluated to yield scores + profile | |
| | categories on each of 7 | |
| | personality trait dimensions, | |
| | each defined by pairs of | |
| | opposite traits. | |
| Personality | Summary of results of | Language-tailored, 7 |
| Profile | personality evaluation, 7 | traits. |
| (Report) | traits, given as 1 of 5 | |
| 84 | categories per trait, with | |
| | brief descriptions (of 2 | |
| | opposite traits defining each | |
| | dimension). | |
| Personality | Narrative guidance report, 7 | Language-tailored, 7 |
| Report 89 | pages, 1 page per personality | traits. |
| | trait, of tailored, personal | Trait-specific |
| | guidance on 8 topics (life- | guidance, 7 traits |
| | transitions, planning, | |
| | decision-making, | |
| | relationships, work & service, | |
| | leisure, learning, and | |
| | environments). | |
| Personality | Self-understanding exercise: | Not tailored in |
| Review | read Personality report, | illustrated |
| (Exercise) | highlight key parts. | embodiment; can be |
| 86 | | language tailored. |
| Personality | Self-discovery exercise: | Language-tailored, 1 |
| Reflection | Tailored instructions to | trait + Activity- |
| & Journal | reflect on/discuss with | tailored, 1 |
| (Exercise) | friend/discuss with group | trait |
| 88 | several questions about | (Contemplative- |
| | personality in transition, | Outgoing) |
| | then make a written entry in | |
| | cumulative, interactive | |
| | journal. | |

Step 2: Balancing Your Life (Characterizing changing, individuaql
life-situation, sources of personal fulfillment & tailored
guidance)

| | | |
|---|---|---|
| Life Change | Structured inquiries on major/ | Not tailored. |
| Inventory | minor/voluntary change | Same instructions + |
| 90 | experienced in 13 life-domains | questions + choices |
| | (mate, family, friends, | for all persons |
| | health, service, work, home, | |
| | self-development, money, | |
| | recreation, spirituality, | |
| | community, other). | |
| Life Change | Characterization of changing | Language-tailored, 1 |
| Index | life-situation including | trait + Trait- |
| (Report) 92 | numerical index indicating | tailored |
| | overall amount of life-change, | guidance, 1 trait |
| | likely level of disruption & | (Responsive - |
| | stress, and emotional | Resilient) |
| | experience, with brief report | |
| | on personality-based reactions | |
| | to life-change. | |
| Life Change | Tailored, numerical index | Language-tailored, 1 |
| Index - | indicating personality-based | trait + Trait- |
| Personality | degree of personal upset & | tailored index, |
| Response | experienced stress to expect | guidance, 1 trait |
| (Report) 92 | from life-change with | (Responsive - |
| | tailored, brief guidance | Resilient) |
| | about coping with stress, | |
| | managing commitments the | |
| | tailoring occurs before the | |
| | personality response is done. | |
| Work Impact | Structured inquiries on 20 | Not tailored |
| Inventory | possible sources of | |
| 94 | fulfillment: importance (5 | |
| | choices: not important, | |
| | slightly important, important, | |
| | very important, extremely | |
| | important); satisfaction (5 | |
| | choices: not satisfied, | |
| | slightly satisfied, partly | |
| | satisfied, mostly satisfied, | |
| | completely satisfied); percent | |
| | from work (none, a little, | |
| | some, most, all). | |
| Work | Numerical index indicating | Trait-tailored (7 |
| Fulfillment | percent of personal | traits) list of sources |
| Index - | fulfillment gained from work | of fulfillment easy |
| Personality | vs. non-work, plus 3 short | & difficult for the |
| Response | lists: 1) most important | personality |
| (Report) | sources of fulfillment; 2) top | |
| 97 | sources of fulfillment from | |
| | work/career; and 3) sources | |
| | of fulfillment most difficult | |
| | to replace, given the | |
| | individual's personality. | |
| | Complete lists available on | |
| | request. | |
| Work | Self-discovery exercise: | Language-tailored, 1 |
| Fulfillment | Tailored instructions to | trait + Activity- |
| Journal | reflect on/discuss with | tailored, 1 trait |
| (Exercise) | friend/discuss with group | (Contemplative- |
| 96 | questions about sources of | Outgoing) |
| | fulfillment from work & non- | |
| | work, past and future, then | |
| | make a written entry in | |
| | cumulative, interactive | |
| | journal | |
| Work Impact | Self-discovery exercise: | Language-tailored, 1 |
| Journal | Tailored instructions to | trait + Activity- |
| (Exercise) | reflect on/discuss with | tailored, 1 trait |
| 100 | friend/discuss with group | (Contemplative- |
| | several questions about | Outgoing) |
| | personality and personal | |
| | difficulty or ease of | |
| | obtaining specific sources of | |
| | fulfillment, then make written | |
| | entry in cumulative, | |
| | interactive journal | |
| Your | Narrative guidance report, 1 | Language-tailored, 7 |
| Personality | paragraph per trait, 7 | traits. |
| In | traits, personality-focused | Trait-specific |
| Transition | guidance on managing life- | guidance, 7 traits |
| (Report) | transitions (extracted from | |
| 95 | Personality Report). | |
| Personality | Self-discovery exercise: | Language-tailored, 1 |
| Summary | Tailored instructions to | trait + Activity- |
| Journal | reflect on/discuss with | tailored, 1 trait |
| (Exercise) | friend/discuss with group | (Contemplative- |
| 98 | several questions about | Outgoing) |
| | personality in transition, | |
| | then make written entry in | |
| | cumulative, interactive | |
| | journal | |

Step 3: Exploring Your Options (Identifying past & future
interests, possible alternative pursuits, narrowing & selecting
options)

| | | |
|---|---|---|
| Retrospective | Prompted listing of past and | Not tailored |
| Look | present, personal interests, | |
| (Exercise) | talents, and preferred | |
| 102 | pursuits, in response to a | |
| | series of open-ended | |
| | questions, to create a | |
| | Memories List, as a partial | |
| | basis for identifying options | |
| | for possible, future | |
| | pursuits. | |
| Prospective | Prompted listing of hopes and | Not tailored |
| Look | dreams for future pursuits | |
| (Exercise) | and accomplishments in | |
| 104 | response to a series of open- | |
| | ended questions, to create a | |
| | Dreams List as a partial | |
| | basis for identifying options | |
| | for possible, future | |
| | pursuits. | |
| Listing | Instructions for using the | Not tailored |
| Possible | Memories & Dreams List | |
| Options | (generated via retrospective | |
| (Exercise) | and prospective looks and | |
| 108 | required for this activity) | |
| | to identify possible, | |
| | alternative future pursuits, | |
| | which together form a Long | |
| | List of Possible Options. | |
| Decision- | Narrative guidance report, 1 | Language-tailored, 7 |
| Making | paragraph per trait, 7 | traits. |
| Pointers | traits, personality-focused | Trait-specific |
| (Report) | guidance on decision-making | guidance, 7 traits |
| 110 | (extracted from Personality | |
| | Report). | |
| Decision- | Self-discovery exercise: | Language-tailored, 1 |
| Making | Tailored instructions to | trait + Activity- |
| Journal | reflect on/discuss with | tailored, 1 trait |
| (Exercise) | friend/discuss with group | (Contemplative- |
| 120 | several questions about the | Outgoing) |
| | individual's personal style of | |
| | decision-making, then make a | |
| | written entry in cumulative, | |
| | interactive journal. | |
| Ranking | Instructions for choosing from | Not tailored |
| Your | the individual's Long List of | |
| Options | Possible Options for the | |
| (Exercise) | future (required for this | |
| 112 | activity) the best-fitting/ | |
| | most desirable alternatives, | |
| | to create a Short List of | |
| | Options. | |
| Selecting | Instructions for deciding | Not tailored |
| Future | which pursuits, activities, | |
| Pursuits | and commitments in the | |
| (Exercise) | individual's Short List of | |
| 116 | Options (created during | |
| | Ranking Your Options and | |
| | required for this activity) | |
| | become part of the | |
| | individual's post-transition | |
| | plans for the future, or | |
| | elements of his or her next | |
| | phase. | |
| Review of | Prompted review of future | Not tailored |
| chosen | pursuits (selected from the | |
| future | individual's Short List of | |
| pursuits | Options and required for this | |
| (Exercise) | activity) with instructions to | |
| 118 | consider the list along with a | |
| | list of top sources of | |
| | fulfillment from work (from | |
| | Work Fulfillment Index), | |
| | passion for future pursuits, | |
| | overall balance, and fit with | |
| | personality. | |

Future Pursuit Tools - Redefining Your Role

| | | |
|---|---|---|
| Name Your | Instructions for creating a | Not tailored |
| future | concise name for the next | |
| pursuits | phase of life (like “Career | |
| (Exercise) | Light” or “Volunteer”), | |
| 132 | prompted by a menu of | |
| | possible names. | |
| Planning | Narrative guidance report, 1 | Language-tailored, 7 |
| Pointers | paragraph per trait, 7 | traits. |
| (Report) | traits, personality-focused | Trait-specific |
| 122 | guidance on personal style of | guidance, 7 traits |
| | planning. | |
| Planning | Self-discovery exercise: | Language-tailored, 1 |
| Journal | Tailored instructions to | trait + Activity- |
| (Exercise) | reflect on/discuss with | tailored, 1 trait |
| 124 | friend/discuss with group | (Contemplative- |
| | several questions about the | Outgoing) |
| | individual's personal style | |
| | of planning, then make a | |
| | written entry in cumulative, | |
| | interactive journal | |
| Goals & | Tailored, printable workbook | Activity-tailored, 2 |
| Planning | with instructions for setting | traits (Structured- |
| Workbook | goals and creating action | Flexible and |
| (Exercise) | plans for each element of the | Practical-Visionary) |
| 136 | next phase, with space for | |
| | capturing specific goals and | |
| | action plans. | |
| Your | Narrative guidance report | Language-tailored, 7 |
| Personality | consisting of the one- | traits. |
| in Brief | paragraph summaries for each | Trait-specific |
| (Report) | of the 7 traits described in | guidance, 7 traits |
| 128 | the Personality Report | |
| | (extracted from the Report). | |
| Personality | Self-discovery exercise: | Language-tailored, 1 |
| Journal | Tailored instructions to | trait + Activity- |
| (Exercise) | reflect on/discuss with | tailored, 1 trait |
| 130 | friend/discuss with group | (Contemplative- |
| | several questions about the | Outgoing) |
| | individual's personality | |
| | overall in taking action to | |
| | execute a transition, then | |
| | make a written entry in | |
| | cumulative, interactive | |
| | journal | |
| Reality | Facility for sending self- | Not tailored |
| Checks | emails as reality-checks, or | |
| (Exercise) | self-prompted evaluations of | |
| 134 | success in achieving goals or | |
| | carrying out plans chosen for | |
| | the next phase, chosen from a | |
| | list of prepared messages | |
| | about common issues for | |
| | transition (sufficient | |
| | challenge, new learning, | |
| | creating opportunities, | |
| | overcoming obstacles, | |
| | managing stress) or other | |
| | self-generated message. E- | |
| | mails are automatically sent | |
| | to the individual's e-mail | |
| | address at the specified | |
| | times. | |
| Transition | Cumulative record of all | (Incorporates all |
| Log 126 | reports and products, | tailoring) |
| | including tailored materials. | |

The present invention accordingly provides apparatus and methods for individuals experiencing transitional events to engage in self-evaluation for guidance during such events. The principles, preferred embodiments, and modes of operation of the present invention have been described in the foregoing specification. The invention is not to be construed as limited to the particular forms disclosed as these are regarded as illustrative rather than restrictive. Moreover, variations and changes may be made by those skilled in the art without departing from the spirit of the invention described in the following claims.

What is claimed is:

1. An evaluation and guidance apparatus to facilitate decisions and activities involved in a transitional event in the life of a person, comprising:
a central manager adapted for interactive communication through a communications link with at least one interactive communicator operable by a person involved in a transitional event to transceive information between the communicator and the central operator;
a personality inventory module associated with the central manager and configured for determining personality information of the person;
an evaluator that uses the personality information to generate a plurality of personality trait scores and a personality profile;
a resource generator that selects one or more activities for the person based on the personality profile for the person to develop an understanding of the transitional event;
a communication generator that selects one or more communication features for communicating with the person as to the activity, based on the personality profile;
an activities module associated with each said activity to direct and record the activity by the person for developing by the person an understanding of the transitional event; and
a facilitation module to assist the person in adjusting the person's behavior relative to the event in view of the activities.

2. The evaluation and guidance apparatus as recited in claim 1, wherein the personality inventory module determines the personality information by presenting to the person a plurality of inquiries related to personal preferences, perceptions, and habits for selecting by the person from at least five scaled alternatives to indicate a relative accuracy of the statements presented in the inquiries.

3. The evaluation and guidance apparatus as recited in claim 2, wherein each of the inquiries provided by the personality inventory module comprises a pair of substantially opposed statements as to a personal preference, perception, or habit, and the scaled response comprises a subjective judgment by the person as to the relative accuracy of the statements as to that person.

4. The self evaluation and guidance apparatus as recited in claim 3, wherein the personality profile comprises a plurality of personality traits and each personality trait is assigned by the evaluator a ranked category on each personality trait.

5. The evaluation and guidance apparatus as recited in claim 1, wherein the personality profile comprises a plurality of personality traits and each personality trait is assigned by the evaluator a personality trait score.

6. The evaluation and guidance apparatus as recited in claim 5, wherein the personality trait dimensions are pairs of opposite characteristics of a personality and the personality trait score is a subjective judgment relative to the characteristic.

7. The evaluation and guidance apparatus as recited in claim 1, wherein the communication features comprise selected words and phrases tailored to be meaningful to the person based on the personality profile.

8. The evaluation and guidance apparatus as recited in claim 1, wherein the communication features comprise selecting a format tailored to the person based on the personality profile for presentation of instructions regarding the activities selected by the resource generator.

9. The evaluation and guidance apparatus as recited in claim 1, wherein the communication features comprise selecting from words and phrases tailored for being meaningful to the person based on the personality trait profile and of a format tailored to the person based on the personality profile for presentation of instructions regarding the activities selected by the resource generator.

10. The evaluation and guidance apparatus as recited in claim 9, wherein tailoring the format comprises selecting from the group comprising the relative brevity of the instructions, the sequencing of instructions, and the presentation of instructions by writing, audio, or video.

11. An individual-actuated evaluation and guidance method for facilitating decisions and activities involved in a transitional event in the life of a person, comprising the steps of:
(a) developing a personality trait score and profile for a plurality of personality traits of a person involved in a transitional event.
(b) selecting at least one tailored communication feature based on the personality profile for presenting reports of the personality profile and activity directions to the person;
(c) selecting one or more activities for the person to engage in based on the personality profile and communicated to the person using the selected communication feature for the person to develop an understanding of the transitional event and the person's traits in relation to that event;
(d) engaging by the person in the activities for developing an understanding of the transitional event, and the person's traits in relation to that event, and modification of the behavior of the person relative to the event in view of the activities; and
(e) receiving completion indicia as to each of the activities and the results thereof.

12. The individual-actuated evaluation and guidance method as recited in claim 11, wherein step (a) developing the personality profile comprises:
presenting to the person involved in the transitional event a plurality of inquiries related to personal preferences, perceptions, and habits for response by the person according to a scale of at least five choices; and
scoring the responses by the person to the inquiries to determine the personality trait score and the personality profile.

13. The individual-actuated evaluation and guidance method as recited in claim 12, further comprising the step of delivering to the person a personality profile report tailored with the selected communication feature based on the personality categories derived from the scored responses by the person to the inquiries, using the tailored communication feature.

14. The individual-actuated evaluation and guidance method as recited in claim 12, wherein presenting each of the inquiries in step (a) comprises presenting a pair of substantially opposed statements as to a personal preference, perception, or habit, and the person responding by choosing one of five alternatives to convey a subjective judgment by the person as to the relative accuracy of the statements.

15. The individual-actuated evaluation and guidance method as recited in claim 12, wherein the personality profile generated in the step (a) comprises a plurality of personality traits and each personality trait is assigned a personality trait score.

16. The individual-actuated evaluation and guidance method as recited in claim 15, wherein the personality traits are pairs of opposite characteristics of a personality and the personality trait score is a subjective choice as to a relative accuracy of the statements related to the characteristic.

17. The individual-actuated evaluation and guidance method as recited in claim 11, wherein the step (b) selecting the communication feature comprises tailoring the terms and phrases used in reports and instructions for activities as being meaningful to the person based on the personality profile.

18. The individual-actuated evaluation and guidance method as recited in claim 11, wherein the step (b) selecting the communication feature comprises tailoring the format of the instructions for the selected activities to the person based on the personality profile.

19. The individual-actuated evaluation and guidance method as recited in claim 18, wherein tailoring the format comprises the relative brevity of the instructions, the sequencing of instructions, and the presentation of instructions by writing, audio, or video.

20. The individual-actuated evaluation and guidance method as recited in claim 11 wherein step (a) evaluating the individual's personality comprises the steps of:
(i) presenting to the person involved in the transitional event a plurality of inquiries related to personal preferences, perceptions, and habits for response;
(ii) scoring the responses by the person to the inquiries to determine scores on each of several personality trait dimensions; and
(iii) on the basis of the scores, assigning one of a plurality of ranked categories as to each personality trait dimension to comprise a personality profile.

20. An individual-actuated evaluation and guidance method for facilitating decisions and activities involved in a transitional event in the life of a person, comprising the steps of:
(a) presenting to a person involved in a transitional event a plurality of pairs of substantially opposite statements involving personal preferences and habits for subjective rating by the person according to a scale of at least five values representative of a degree of agreement with the statements;
(b) scoring the responses by the person to the pairs of statements to determine a personality profile, the personality profile comprising a plurality of pairs of substantially opposite personality traits and a personality trait score reflecting the association of the person with the personality trait, the personality trait score based on evaluating the ratings by the person of each of the statements and each statement associated with one of the personality traits, each of the personality trait scores comprising a subjective rating relative to the personality traits;
(c) selecting a communication feature based on the personality profile for presenting report information and activity directions to the person based on the personality trait scores;
(d) delivering to the person a personality report based on the scored responses by the person to the inquiries using the selected communication feature;
(e) selecting one or more activities for the person to engage in based on the personality profile and communicated to the person using the selected communication feature for the person to develop an understanding of the transitional event;
(f) engaging by the person in the activities for developing an understanding of the transitional event; and
(g) modifying the behavior of the person as to the transitional event based on completion of the activities.

21. The individual-actuated evaluation and guidance method as recited in claim 20, wherein the step (c) selecting the communication feature comprises selecting from the group comprising tailoring the terms and phrases used in reports and instructions for activities as being meaningful to the person based on the personality profile and tailoring the format of the instructions for the selected activities to the person based on the personality profile.

22. The individual-actuated evaluation and guidance method as recited in claim 21, wherein tailoring the format comprises selecting from the group comprising the relative brevity of the instructions, the sequencing of instructions, and the presentation of instructions by writing, audio, or video.
